(19) United States
(12) Patent Application Publication
(10) Pub. No.: US 2022/0109770 A1
(43) Pub. Date: Apr. 7, 2022

(54) MEDIA CHARACTERISTIC SCANNING

(71) Applicant: Hewlett-Packard Development Company, L.P., Spring, TX (US)

(72) Inventor: John J. Cantrell, Vancouver, WA (US)

(73) Assignee: Hewlett-Packard Development Company, L.P., Spring, TX (US)

(21) Appl. No.: 17/261,189

(22) PCT Filed: Mar. 29, 2019
(86) PCT No.: PCT/US2019/024970

§ 371 Date: Jan. 19, 2021

(51) Int. Cl. H04N 1/00

(52) U.S. Cl. CPC H04N 1/00779; H04N 1/00726; H04N 1/00334

(57) ABSTRACT

An example marking device may include a sensing device, a media conveyance component, and a controller. The sensing device may be arranged in a media path to sense data encoded on media. The media conveyance component may feed a medium into the media path and advance the medium a first distance less than a length of the medium. And the controller may receive timing signals indicative of read timing markings from the sensing device, receive data signals indicative of media characteristic markings from the sensing device, and alter marking parameters of the marking device based on the to be received data signals.

### BACKGROUND

Some media types may vary across batches. For instance, thermally reactive media, which refers to media that may include parts and/or structures that may react to temperature by changing color, may vary across batches. For instance, different batches of media may potentially react differently to the same heating patterns.

Thus, at times, markings devices (e.g., print devices) may be calibrated based on the characteristics of a certain medium. This may be the case for thermally-reactive media, as well as other types of media. For instance, indications of media characteristics may be represented on media to enable the marking device to calibrate its marking parameters to correspond to the media characteristics. In one example, these indications of media characteristics may take the form of barcodes (e.g., on a back side or non-print side of a medium) that may be read by a sensor of a marking device. And the marking device may use information encoded in the barcode to tune the marking parameters of the marking device, such as to achieve standard color, contrast, saturation, etc.

### BRIEF DESCRIPTION OF THE DRAWINGS

Various examples will be described below by referring to the following figures.

FIG. 1 is an illustration of an example marking device;

FIG. 2 is a flow diagram for an example method of altering marking parameters of a marking device;

FIG. 3 illustrates an example medium with markings and provides a close-up view of an example set of markings;

FIG. 4 is a table illustrating timing and data values corresponding to the example set of markings of FIG. 3; and

FIG. 5 is a block diagram of an example marking device.

Reference is made in the following detailed description to accompanying drawings, which form a part hereof, wherein like numerals may designate like parts throughout that are corresponding and/or analogous. It will be appreciated that the figures have not necessarily been drawn to scale, such as for simplicity and/or clarity of illustration.

### DETAILED DESCRIPTION

At times, a number of components of print devices may be used to convey media (e.g., sheets of media, individually, referred to herein as a “medium,” such as a sheet of paper) through a print zone in which markings may be formed upon the media. In some cases, the speed at which these conveying components move media through a media path may vary. For example, for an example medium, a first portion of the medium may pass in proximity to a marking component (e.g., to form markings) at a first speed and a second portion of the medium may pass in proximity to the marking component at a second speed (e.g., the first and the second speeds being different). In fact, a particular medium may encounter a number of slight variations (or significant, in some cases) in conveyance speed during a print process. While the magnitude of any variation of conveyance speed may be so small as to not affect the formation of markings on a medium, media conveyance speed variation may present other challenges.

For example, as described above, there may be a desire to identify media, such as to identify characteristics of the media. And it may be desirable to use a number of possible forms of markings (e.g., alphanumeric markings, barcodes, QR codes, etc.) on the media, such as on a side of a medium (e.g., a front or a back side of the medium). However, possible media conveyance speed variations may render reading the characteristic identifying markings challenging. Taking the example of a barcode by way of example, if a conveyance speed were to increase while scanning a bar of the barcode, the system may not properly read the value of the bar (e.g., the size of the bar may be incorrectly determined, double bars may be read as a single bar, the bar may be missed altogether, etc.). Similarly, if a conveyance speed were to decrease while scanning a bar, the system may also not properly read the value of the bar (e.g., the size of the bar may be incorrectly determined-potentially as being larger than is really the case, a single bar may be read as double bars, etc.).

There may be an interest, therefore, in being able to read characteristic identifying markings in spite of a varying media conveyance speed. One approach to overcoming varying media conveyance speed is the use of larger media characteristic markings (e.g., using a large barcode), so as to reduce the impact of any variation in media conveyance speed. However, this approach may be less desirable because it may mean that the media may need to be conveyed twice through a media path: once to read the characteristic identifying markings, and a second time to form markings on the media.

The present disclosure proposes using read timing markings in order to assist in reading media characteristic markings. For instance, distinct read timing markings may be included in proximity to media characteristic markings, and the read timing markings may convey timing information to reduce the impact of variability in conveyance speed. By way of example, in a case in which media characteristic markings include a barcode, the read timing markings may also include a barcode. The barcode of read timing markings may indicate, for instance, different cycles or half cycles (or other timing cycle) at which a sensor device is to sense counterpart media characteristic markings. For instance, if a read timing marking bar remains in the field of view of the sensor (but is nevertheless of a larger size due to slowing of the conveyance mechanism) the system may be capable of determining that a corresponding space or bar of the media characteristic markings corresponds to a single timing cycle (or half cycle, as may be the case in some implementations, etc.).

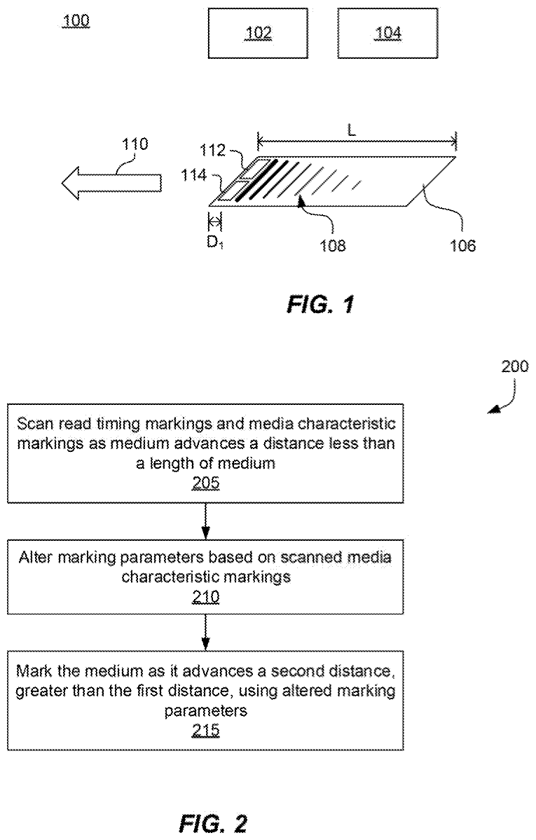

The foregoing may be illustrated with reference to FIG. 1, which illustrates an example system comprising an example marking device 100, an example sensing device 102, and example marking parameters 104. Example marking device 100 may include a print device capable of forming markings on media. In marking device 100, none of the supporting structures (e.g., conveyance mechanisms, media path components, chassis, etc.) are illustrated in order to focus on operation of sensing device 102 and marking parameters 104 in response to reading of media characteristic markings 112 and read timing markings 114 of example medium 106. Indeed, FIG. 1 illustrates an example medium 106 being conveyed in a direction indicated by arrow 110 (e.g., along a media path). Medium 106 also includes markings 108, which may be formed thereon by marking device 100. Examples of marking device 100 may include inkjet printers, electrophotographic printers, thermal printers, and dye sublimation printers, without limitation.

Sensing device 102 may comprise sensors capable of reading markings (e.g., media characteristic markings, read timing markings, etc.). For instance, sensing device 102 may include optical sensors (e.g., photoconductive sensors, photovoltaic sensors, photodiodes, etc.) and electromagnetic sensors (e.g., conductivity sensors, capacitance sensors, etc.) without limitation. In one implementation, for instance, sensing device 102 may include optical sensors arranged within a media path of marking device 100 to be able to read markings on media that is conveyed through the media path. A first sensor may be arranged to read media characteristic markings, for instance, and may include an emitter and a receiver. A second sensor may be arranged to read timing markings, for instance, and may also include an emitter and a receiver. The read values may be used to alter marking parameters.

Marking parameters 104 refer to values, potentially stored in a computer-readable medium, that allow marking device 100 to correlate input data (e.g., an image) to signals used by a marking component (e.g., a printhead) to form markings on media, and which include desirable color levels, levels of hue, levels of contrast, levels of saturation, etc. As noted, for particular media the relationship between input data and signals for marking formation may vary based on a number of different factors (e.g., a particular batch from which media comes, environmental conditions, such as humidity, thermal status of the printhead, etc.). It may be desirable, therefore, to alter marking parameters periodically, such as prior to forming markings on a medium. In one case, this may include reading media characteristic markings to determine characteristics of media, and altering marking parameters. The altered marking parameters may be fetched from memory of marking device 100 or from an external source, and used to alter the marking parameters of marking device 100 (e.g., loaded into memory). The altered marking parameters may be tuned for a particular medium, such as medium 106.

Medium 106 is illustrated as having media characteristic markings 112 and read timing markings 114, which may comprise a number of different forms. For example, in one case, media characteristic markings 112 and read timing markings 114 may take the form of barcodes. The use of barcodes may be desirable in cases in which sensing device 102 comprises one-dimensional sensors, which are sensors that sense one line of a surface at a time. In contrast, using other sensors, such as two-dimensional optical sensors, may enable reading more than one line at a time. Thus, in other implementations, media characteristic markings 112 may take other forms, such as alphanumeric-based markings, shape-based markings, and QR codes by way of example. And read timing markings 114 may take a number of possible corresponding forms to assist sensing device 102 in reading the media characteristic markings 112. For instance, based on the direction of conveyance, read timing markings 114 may take the form of bars or shapes to define timing units (e.g., clock cycles, half cycles, and the like). The present description will use the example of media characteristic markings 112 taking the form of a barcode, but it is to be understood that this is merely to illustrate claimed subject matter. Those of skill in the art will understand how the teachings of the barcode implementation extend to other non-barcode-based implementations.

It is also noted that the present description refers to operation of sensing device 102 with the terms “read,” “reading,” “scan,” “scanning,” “sense,” “sensing,” and like terms. These terms are used to simplify discussion without getting into the particular mechanism that sensing device 102 might employ to detect markings, such as media characteristic markings 112. As used herein, these terms refer to detecting, through an appropriate mechanism (e.g., optically or electromagnetically), markings such as media characteristic markings 112 and read timing markings 114. Thus, for instance, in the case in which sensing device 102 comprises optical sensors, reading media characteristic markings 112 by sensing device 102 may comprise receiving electromagnetic radiation (EMR), such as in the form of visible or non-visible light, at a receiver of sensing device 102. Sensing device 102 may, in response to reception of the EMR, generate signals (e.g., current pulses), which may be transmitted to a controller of marking device 100 for interpretation with reference to executed instructions (e.g., computer-executed instructions to alter marking characteristics of marking device 100 based on detected media characteristic information).

Returning to the discussion of medium 106, it is also noted that marking device 100 may form markings 108 on medium 106, as illustrated by a number of lines of different length and thickness. These formed markings 108 may be formed using marking parameters that have been altered based on media characteristic information that was encoded in media characteristic markings 112. As shown, medium 106 may be conveyed a first distance, D₁, which may be less than a length L of medium 106, in which media characteristic markings 112 and read timing markings 114 may be read. In one example, D₁, may correspond approximately to a border or a margin of medium 106. Media characteristic markings 112 may encode media characteristic information, a pointer to a lookup table (LUT) and/or a pointer to an external resource (e.g., an external server) and the like. Media characteristic markings may be used to alter marking parameters of marking device 100. For instance, altered marking parameters may be stored and accessed by a controller in order to be used by marking device 100, as illustrated by marking parameters 104. And marking parameters 104 may be used by marking device 100 to form markings 108 on medium 106. It may be that markings 108 may differ (e.g., different color levels, different contrast, different hues, different saturation) based on (altered) marking parameters 104, such as compared with a default set of marking parameters (e.g., as set upon manufacture of marking device 100, as set based on a previous medium or set of media, and the like).

Operation of marking device 100 may be understood by reference to FIG. 2, which is a flow diagram for an example method 200. Reference will be made back to the example components of FIG. 1. At a first block 205, a sensing device (e.g., sensing device 102) may scan read timing markings (e.g., read timing markings 114). Read timing markings may be used to also scan media characteristic markings 112. Scanning, by the sensing device, of read timing markings and media characteristic markings may be performed as a medium (e.g., medium 106) advances a distance (e.g., D₁) that is less than a length of the medium (e.g., L).

Block 210 illustrates altering marking parameters (e.g., marking parameters 104) based on scanned media characteristic markings. Thus, for example, a controller of marking device 100 may receive signals from sensing device 102 and may use the received signals to determine corresponding media characteristic information (e.g., such as by consulting a LUT or an external source) for the medium. The media characteristic information may be used to alter the marking parameters of marking device 100.

Block 215 illustrates marking the medium as it advances a second distance (e.g., L-D₁), which is greater than the first distance, using the marking parameters altered at block 210. The marking of the medium may be performed without reversing a direction of conveyance (such as after conveying the medium the first distance D₁). Thus, in the example of a thermal printer forming markings on a thermally-reactive medium, heating pulses by a printhead may cause markings to form on the thermally-reactive medium. The heating pulses may be generated based on the altered marking parameters. Of course, in other implementations, the use of altered marking parameters may vary, such as based on a particular marking technology, as would be understood by those of skill in the art.

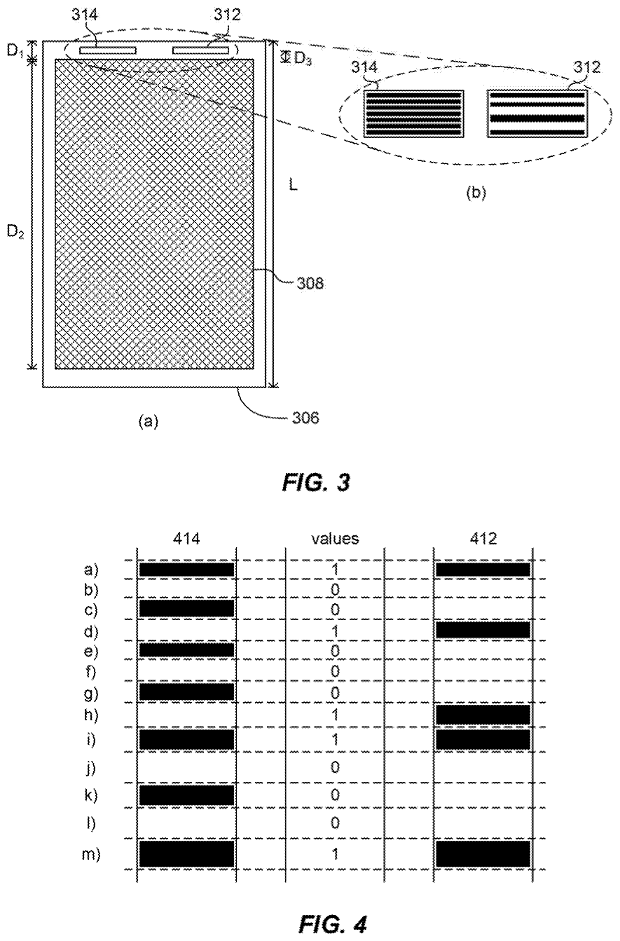

Turning to FIG. 3, an example medium 306 is illustrated. FIG. 3 includes two parts, a first part, part (a), shows the entire medium 306, and a second part, part (b), is a zoomed view of one implementation of media characteristic markings 312 and read timing markings 314. Medium 306 may be similar to medium 106, illustrated in FIG. 1. Indeed, in addition to media characteristic markings 312 and read timing markings 314, medium 306 may include markings 308, such as may be formed by a marking device (e.g., marking device 100). Part (a) also shows different lengths, for instance a length L of medium 306, a first distance D₁, which may correspond to a distance that medium 306 may be conveyed while media characteristic markings 312 and read timing markings 314 are read (e.g., by sensing device 102). D₂ illustrates a distance, greater than D₁, corresponding to a distance that medium 306 may be conveyed while markings 308 are formed, such as based on read media characteristic markings 312.

Part (a) of FIG. 3 also shows a third distance, D₃, which corresponds to a distance, less than both D₁ and D₂, that medium 306 may be conveyed in a reverse direction, such as in cases in which reading of media characteristic markings 312 causes medium 306 to advance far enough that medium 306 may have to be reversed a small distance prior to forming markings 308.

Next, moving to part (b) of FIG. 3, the barcode example of media characteristic markings 312 and read timing markings 314 is continued. In this example, read timing markings 314 are shown as a series of bars and gaps spaced regularly. In one case, each bar and each gap represent a half cycle and may be used to enable reading media characteristic markings 314, which are shown as differently-sized and spaced bars. Again, illustration using the barcode implementation is not intended to be limiting, and any other number of different markings may be used without straying from claimed subject matter.

To illustrate how the markings of FIG. 3 may be used, attention is directed to FIG. 4. FIG. 4 is an illustration of the markings shown in part (b) of FIG. 3, such as may be read by a sensing device (e.g., sensing device 102). The table of FIG. 4 includes dotted and vertical lines along with alphanumeric values to assist the reader in understanding the markings. It is noted that the size of the different bars and gaps may vary based on a speed of conveyance of a medium (e.g., medium 306) upon which the media characteristic markings 312 and read timing markings 314 may be formed. For instance, rows h-m appear to be larger than rows a-g, such as based on a higher speed of conveyance while the values of rows a-g are read, as compared to a lower speed of conveyance while the values of rows h-m are read.

The first column from the left illustrates read timing markings 414 and the last column on the right illustrates media characteristic markings 412, which correspond to read timing markings 314 and media characteristic markings 312, respectively. The values column illustrates the binary values corresponding to media characteristic markings 412.

Starting with row a, a bar of read timing markings 414 may be indicative of a start of a timing cycle (e.g., a full or partial cycle) indicating to a controller of a marking device that a corresponding bar of media characteristic markings 412 starts at the beginning of the timing cycle and should end at the end of that timing cycle. Thus, a first bar of media characteristic markings 412 corresponding to the timing cycle of row a may have a value of 1.

Rows b and c indicate successive timing cycles for which corresponding bars of media characteristic markings 412 are not read (the value of the media characteristic markings during these timing cycles being 0). However, the timing cycle of row d (in which there is no bar present) may be used to assist in identifying the corresponding bar in row d of media characteristic markings 412, yielding a value of 1 in this case.

Next, rows e-g, yield values of 0. Rows h and i both include bars for media characteristic markings 412. This example also shows how on read timing cycles of rows h and i, media characteristic values (of 1 in this case) of these rows may be determined.

Rows j-l will also yield values of 0, and the final row, row m, would yield a 1. Thus, in this case, the controller may determine media characteristic information, represented as 1001000110001 in this example, which may be a pointer to a LUT or an external source (or even, potentially, representative of marking parameters).

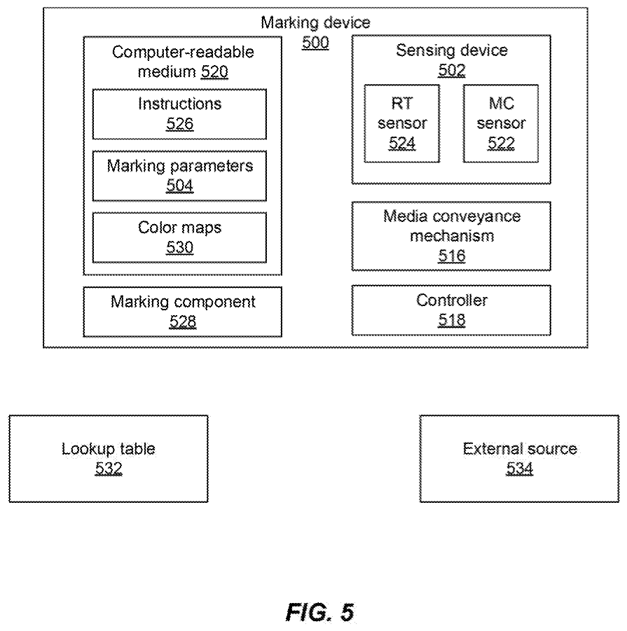

To illustrate one example of how a marking device may alter its marking parameters based on media characteristic markings, an example system is illustrated in FIG. 5, which shows a marking device 500, which is similar to marking device 100, illustrated in FIG. 1. FIG. 5 also shows a lookup table (LUT) 532, which is shown externally to marking device 500, but may be included internally in marking device 500 in some implementations, such as in a computer-readable medium. External source 534 represents a number of possible sources, such as external computing devices (e.g., servers) or mobile devices (e.g., smart phones or tablets), by way of example. At times, LUT 532 may be encoded or included on external source 534.

Marking device 500 may include a computer-readable medium 520, which may include a form of storage, such as a memory, and may take a number of different possible non-transitory forms. For instance, computer-readable medium 520 may be in the form of volatile (e.g., random-access memory (RAM)) or non-volatile memory (e.g., read-only memory (ROM)), such as electromagnetic memory (e.g., a magnetic hard drive, DRAM, flash memory, electrically erasable programmable ROM (EEPROM), etc.), and resistive memory (e.g., phase change memory (PCRAM), resistive RAM (RRAM), etc.), by way of non-limiting example.

Instructions 526, marking parameters 504, and color maps 530 are examples of data and information that may be stored on computer-readable medium 520. Instructions 526 refer to computer-executable and/or processor-executable instructions that may be executed by a processor, such as a controller, of a device in order to cause marking device 500 to function or operate and also to cause components of marking device 500 to function or operate. By way of example, instructions 526 may include instructions to cause sensing device 502 to read timing markings and media characteristic markings (e.g., read timing markings 314 and media characteristic markings 312). Instructions 526 may also include instructions to alter marking parameters of the marking device 500. Instructions 526 may also include instructions to cause marking device 500 to form markings on a medium.

Marking parameters 504 may be similar to marking parameters 104, discussed above, and thus operate similarly as marking parameters 104. Color maps 530 refer to a form of marking parameters that map input colors from an image of a print job to marking device output parameters. Color maps 530 may include a number of different color maps, such as may be selected based on media characteristic information, and used to alter marking parameters. For example, in response to receiving media characteristic information, a corresponding color map may be determined (such as by referring to LUT 532) and the determined color map may be fetched from color maps 530 and loaded into marking parameters 504 to enable marking of a medium, such as using marking component 528.

Marking component 528 may refer to, for instance, an inkjet printhead, an electrophotography-based laser scanning and developing unit, or a printhead of heating elements for a thermal printer, by way of example. Marking component 528 may receive signals from controller 518 and may form markings on media based on the received signals. In the case of a thermal printer, for example, in response to receiving signals from controller 518, electrical current may be pulsed through heating elements of marking component 528 to generate heat in proximity to desired areas of a medium. The heat may in turn cause the formation of markings on the medium.

Sensing device 502 may be similar to sensing device 102, discussed previously. In one implementation, sensing device 502 may include independent sensing components. Indeed, in the implementation illustrated in FIG. 5, there is a read timing (RT) sensor 524 and a media characteristic (MC) sensor 522. As noted above in the discussion of FIG. 1 with regards to sensing device 102, the sensing device may be one of a number of different forms. Similarly, sensing device 502, and therefore RT sensor 524 and MC sensor 522, may take a number of different forms. In one case, for instance, each of RT sensor 524 and MC sensor 522 may comprise one-dimensional optical sensors. In FIG. 5, the blocks representing RT sensor 524 and MC sensor 522 are arranged side-by-side. Similarly, within a media path of marking device 500, RT sensor 524 and MC sensor 522 may be arranged side-by-side to correspond to the side-by-side relationship of read timing markings (e.g., read timing markings 314 in FIG. 3) and media characteristic markings (e.g., media characteristic markings 312 in FIG. 3) on media. For instance, the arrangement of RT sensor 524 and MC sensor 522 within a media path may be such that as a medium with read timing markings and media characteristic markings passes within the field-of-view (FOV) of RT sensor 524 and MC sensor 522, respectively, RT sensor 524 will generate signals that controller 518 may use to facilitate determination of media characteristic information encoded in media characteristic markings (or stored at a location indicated by media characteristic markings). In one example, for instance, as read timing markings are being read by RT sensor 524, media characteristic markings may be concurrently read by MC sensor 522, such as was described in relation to FIGS. 3 and 4.

Movement of media in proximity to sensing device 502 and marking component 528 may be controlled by media conveyance mechanism 516, which may comprise a mechanism capable of causing motion of media. For instance, in one implementation, media conveyance mechanism may comprise a roller that may rotate with relation to media and due, for example, to friction between a surface of the roller and the media, cause the media to move with respect to an axis of rotation of the roller. In another example, a conveyer belt-like system may be used in which a clamp or friction between the media and the belt-like surface of the conveyer belt may cause the media to move. These are, of course, but two examples of a number of possible mechanisms for conveying media, and the subject matter of the claims is not intended to be limited thereto. Like marking component 528, media conveyance mechanism 516 may also operate in response to signals received from controller 518. For instance, marking device 500 may receive a data file including image data to be used in order to form markings on print media, and controller 518 may cause media conveyance mechanism 516 to advance a medium in proximity to marking component 528 and may cause marking component 528 to form markings on the medium.

Controller 518 may include a combination of hardware and processing to enable execution of instructions, such as instructions 526, to enable marking of media, among other things. For instance, controller 518 may comprise a number of integrated circuits (ICs) that may be accessed by firmware (FW) and/or software (SW) in order to execute instructions 526. Examples of controller 518 may include, for instance, field-programmable gate arrays (FPGAs), general purpose processing units, application-specific integrated circuits (ASICs), and the like, without limitation.

Controller 518 may be able to transmit and receive signals with internal and/or external components and devices (e.g., via wired or wireless connections). For instance, controller 518 may be able to exchange signals with components illustrated in marking device 500 and also external components and devices, such as external source 534. External source may be a remote device, such as a server, which may store color maps and related marking parameters. There may be a desire, for instance, to provide color maps to marking device 500 that were not available when marking device 500 was manufactured. External source 534 may thus be able to provide up-to-date color maps to allow marking device 500 to provide desired functionality, such as without potentially onerous FW and/or SW updates.

To illustrate how external source 534 may be used using a non-limiting example, media characteristic information may be obtained by scanning media characteristic markings. The media characteristic information may not be found within LUTs of marking device 500 (e.g., within computer-readable medium 520). Marking device 500 may then transmit the media characteristic information to external source 534, which may consult LUTs stored thereon (or, potentially, also remotely, such as shown by LUT 532) and may find color maps corresponding to the received media characteristic information. The color maps may then be transmitted back to marking device 500 and marking parameters of marking device 500 may be altered based on the newly-received color maps. Of course, this is but one example of using external source 534 and is not intended to be taken in a limiting sense.

With the foregoing in mind, the following example operation of a marking device, such as example marking device 500, is provided. The marking device may comprise a sensing device (e.g., sensing device 502) and a media conveyance component (e.g., media conveyance component 516). The sensing device may be arranged in a media path to sense data encoded on media (e.g., read timing markings 314 and media characteristic markings 312 of FIG. 3). The media conveyance component may feed a medium (e.g., medium 306 of FIG. 3) into the media path and may advance the medium a first distance (e.g., D₁ of FIG. 3) less than a length of the medium (e.g., L of FIG. 3). The marking device may also include a controller (e.g., controller 518). The controller may receive timing signals indicative of read timing markings from the sensing device (e.g., from RT sensor 524). The controller may use the to be received timing signals to receive data signals indicative of media characteristic markings from the sensing device (e.g., from MC sensor 522). And the controller may alter marking parameters (e.g., marking parameters 504) of the marking device based on the to be received data signals, which are indicative of media characteristic markings.

In one example case, the marking device may have a computer-readable medium (e.g., computer-readable medium 520) with color maps (e.g., color maps 530) stored thereon. In this case, altering of marking parameters may include selecting a different color map to be used by a marking component (e.g., marking component 528) of the marking device.

Additionally, the computer-readable medium may have instructions (e.g., instructions 526) that may cause the marking device to do a number of things (e.g., via a controller, such as controller 518). For instance, when the instructions are executed by a processor, such as controller 518, the marking device may scan, using the sensing device, read timing markings from a medium conveyed a first distance less than a length of a medium, as discussed above. The marking device may scan (also using the sensing device) media characteristic markings from the medium based on the to be scanned read timing markings, as also discussed above. The executed instructions may also case the marking device to alter marking parameters of the marking device based on the to be scanned media characteristic markings, and subsequently form markings on the medium based on the to be altered marking parameters, such as without changing a direction of conveyance of the medium.

As should be apparent based on the foregoing, there may be an interest in being able to read media characteristic identifying markings in spite of potentially varying media conveyance speed (without necessarily using large sets of markings). And using read timing data (e.g., in the form of read timing markings) in combination with media characteristic data (e.g., in the form of media characteristic markings) may be one approach for achieving the desired ability to read media characteristic data, without limitation.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

What is claimed is:

1. A marking device comprising:
a sensing device arranged in a media path to sense data encoded on media;
a media conveyance component to feed a medium into the media path and advance the medium a first distance less than a length of the medium;
a controller to:
receive timing signals indicative of read timing markings from the sensing device;
using the to be received timing signals, receive data signals indicative of media characteristic markings from the sensing device; and
alter marking parameters of the marking device based on the to be received data signals.

2. The marking device of claim 1 comprising:
a computer-readable medium having color maps stored thereon;
wherein to alter marking parameters, the controller is further to select a different color map to be used by a marking component of the marking device.

3. The marking device of claim 1 comprising a marking component to form markings on thermally reactive media.

4. The marking device of claim 1, wherein the media conveyance component is further to feed the medium a second distance, the second distance greater than the first distance.

5. The marking device of claim 4 comprising a marking component to apply markings to the medium while feeding the medium the second distance and without reversing the medium.

6. The marking device of claim 4, wherein the first distance corresponds to a length of a border around an image formed on the medium with a marking component.

7. The marking device of claim 4, wherein subsequent to feeding the medium the first distance, the media conveyance component to reverse the medium a third distance, less than the first distance.

8. The marking device of claim 1, wherein the sensing device comprises two one-dimensional sensors.

9. The marking device of claim 8, wherein a first of the two one-dimensional sensors is to read the read timing markings, and a second of the two one-dimensional sensors is to read the media characteristic markings.

10. The marking device of claim 1, wherein the media characteristic markings comprise a pointer to a lookup table or external source.

11. A method comprising:
scanning, by a sensing device, read timing markings and media characteristic markings from a medium advanced a first distance less than a length of the medium in a media path of a marking device;
altering, by a controller of the marking device, marking parameters based on the scanned media characteristic markings; and
marking the medium as it advances a second distance, greater than the first distance, using the altered marking parameters.

12. The method of claim 11, wherein scanning the media characteristic markings is based on the scanned read timing markings.

13. A non-transitory computer-readable medium comprising instructions that when executed by a processor are to cause a marking device to:
scan, using a sensing device, read timing markings from a medium conveyed a first distance less than a length of a medium;
scan, using the sensing device, media characteristic markings from the medium based on the to be scanned read timing markings;
alter marking parameters of the marking device based on the to be scanned media characteristic markings; and
form markings on the medium based on the to be altered marking parameters without changing a direction of conveyance of the medium.

14. The computer-readable medium of claim 13 further comprising instructions that when executed by the processor are to cause the marking device to convey the medium a second distance, greater than the first distance, wherein the to be formed markings are to be formed while the medium is conveyed the second distance.

15. The computer-readable medium of claim 13 further comprising instructions that when executed by the processor are to store a new set of marking parameters received from an external source.
